(19) United States
(12) Patent Application Publication
(10) Pub. No.: US 2026/0259139 A1
(43) Pub. Date: Sep. 3, 2026

(54) FLUID ANALYSIS SYSTEM, WATER-CONDUCTING HOUSEHOLD APPLIANCE AND METHOD FOR DETERMINING A CONCENTRATION

(71) Applicant: ams Sensors Germany GmbH, Jena (DE)

(72) Inventors: Boon Chong CHEAH, Geldrop (NL); Bobby DANIEL, Eindhoven (NL); Markus BUSZ, Kraftsdorf / OT Oberndorf (DE)

(21) Appl. No.: 18/842,522

(22) PCT Filed: Jan. 17, 2023
(86) PCT No.: PCT/EP2023/050996

§ 371 Date: Aug. 29, 2024

(30) Foreign Application Priority Data
Mar. 1, 2022 (DE) 10 2022 104 818.7

(51) Int. Cl. G01N 21/64

(52) U.S. Cl. CPC G01N 21/64; G01N 2021/6419; G01N 2021/6491

(57) ABSTRACT

A fluid analysis system for determining a concentration of a detergent component in a fluid includes a light source configured to illuminate the fluid with light. The light includes a first wavelength corresponding to an excitation wavelength of the detergent component. The system also includes a detection unit positioned and configured to measure an intensity of the resultant fluorescence generated by the detergent component. The system further includes a processing unit configured to determine the concentration based on the measured intensity by means of fluorescence spectroscopy. The resultant fluorescence includes monomer emission and excimer emission of the component. For determining the concentration, the processing unit is configured to perform ratiometric fluorescence spectroscopy on the measured intensity.

The present invention relates to a fluid analysis system, a water-conducting household appliance and a method for determining a concentration.

### BACKGROUND OF THE INVENTION

Detergents used for cleaning in water-conducting home appliances such as washing machines and dishwashers typically comprise surfactants, builders, bleaches and polymers. Typically, before the beginning of the cleaning process users of the appliance introduce an amount of detergent into the respective appliance, which the user subjectively considers appropriate. Some detergents on their packaging provide a suggestion of how much detergent to add, e.g. by having the user first estimate a load and/or a dirtiness of the items to be cleaned, and then convert this into an amount of detergent to be added, for example in terms of measuring the amount by means of a bottle cap or a spoon. As a result, end users tend to overdose to ensure that the laundry or dishes are cleaned. Overdosing, however, is not environmental as most detergents comprise corrosive or non-biodegradable chemicals.

Moreover, having the user estimate an amount of detergent is a substantially inaccurate method as different loads and degrees of dirtiness require a different dosage of the detergent. Moreover, different detergents, whether in powder or liquid form, feature different concentrations of different surfactants, which are the main cleaning component in a detergent. This in turn leads to a broad spectrum of detergent qualities available on the market. Likewise, detergents that are pre-portioned as capsules or pods result in the same amount of detergent for each washing cycle, hence also not letting a user adjust for different loads or degrees of dirtiness.

Current approaches to more accurately dose detergents in water-conducting home appliances employ a turbidity sensor in combination with a resistance measurement from a motor, e.g. of a washing machine, and a pH sensor. By doing this, a dirtiness of the items within the appliance, their load and the hardness of the water can be monitored, hence enabling a more accurate estimation of the optimal amount of detergent required. This estimation is either communicated to a user, e.g. as a prompt to introduce a specific amount, or an automatic dispenser is controlled based on this estimation.

Nevertheless, none of the existing approaches consider the detergent type or its quality, which as mentioned before can vastly vary. To overcome this limitations, some appliances manufacturers offer detergents that are specifically designed for their appliances such that an optimal dosage can be determined only based on load and degree of dirtiness, for instance. However, only using a single specific detergent is neither user friendly, nor energy efficient or cost effective.

Thus, an object to be achieved is to provide a fluid analysis system for water-conducting home appliances that monitors an amount of a component of a detergent in a fluid and a method for determining said concentration. A further object is to provide a water-conducting home appliance comprising such a fluid analysis system.

These objects are achieved with the subject-matter of the independent claims. Further developments and embodiments are described in dependent claims.

### SUMMARY OF THE INVENTION

The improved concept is based on the idea of optically quantifying, for example during a washing cycle, an amount of a cleaning component of the detergent that is dissolved in a liquid, e.g. in water, forming a water-detergent solvent. As detergents differ in terms of a concentration of their contained cleaning component, merely determining a total amount of detergent within the solvent does not suffice. Instead, the present disclosure provides a fluid analysis system that is operable to directly determine whether a concentration of said cleaning component for the washing cycle is too low, too high, or within an optimal range. The determination is based on fluorescent spectroscopy of a detergent component that is contained in most, if not all, detergents available on the market. Particularly, the improved concept does not rely on any additional marker agents, such as pyrene, that are added to the detergent specifically for the purpose of performing spectroscopic measurements, but instead relies on a fluorescent spectroscopic measurement of a component of the detergent that is originally contained, e.g. a cleaning component. Moreover, the improved concept provides a fluid analysis system that can be realized with a small form factor, and has no loose optical components, moving mechanical parts or bulky components.

In an embodiment, a fluid analysis system for determining a concentration of a detergent component in a fluid comprises a light source that is configured to illuminate the fluid with light that comprises a first wavelength corresponding to an excitation wavelength of the detergent component. The fluid analysis system further comprises a detection unit positioned and configured to measure an intensity of the resultant fluorescence generated by the component, and a processing unit configured to determine the concentration based on the measured intensity by means of fluorescence spectroscopy.

The principle of operation being based on fluorescence spectroscopy, also known as fluorimetry or spectrofluorometry, means that the fluid analysis system is configured to optically excite electrons in molecules of the component via photon absorption of the input light. This in turn induces a luminescence, i.e. a spontaneous emission of light from these molecules. Since the luminescence is a result of the aforementioned absorption of photons, this type of luminescence is also referred to as photoluminescence. More specifically, due to the photoluminescence normally being a result of singlet-singlet electronic relaxations, the photoluminescence is referred to as fluorescence, which is characterized by a lifetime in the order of nanoseconds. Typically, the emitted light via fluorescence is characterized by a longer wavelength, i.e. a lower photon energy, than the absorbed radiation.

For realizing the fluorescence spectroscopy of the component of the detergent, the fluid analysis system comprises a fluorometer-type arrangement having an input light source that emits light at a first wavelength, e.g. UV light, that corresponds to an excitation wavelength of the targeted compound. For example, the light source is a broad emission light source, such as an LED, whose emission spectrum comprises the first wavelength, or it is a narrow-emission light source, such as a laser, emitting a narrow-band spectrum comprising the first wavelength. The light source emits the light such that it illuminates the fluid. For example, the fluid to be illuminated is passed through a conduit that is transparent at least in a region of illumination. Alternatively, the fluid can be located in a container or reservoir that is transparent at least in a region of illumination. Transparent in this context means that a material of the conduit, container or reservoir, such as a cuvette, is transmissive for light at the excitation wavelength and at an emission wavelength of the resultant fluorescence.

The fluid analysis system further comprises a detection unit which is arranged such that it can capture photons emitted by the component of the fluid due to the resultant fluorescence. The detection unit comprises means to convert photons into an electronic signal in the form of electronic charge, current or voltage. Said means can be realized by means of a photodetector or an optical spectrometer, the latter being able to separate and measure spectral components of the photons received. The detection unit generates an electronic detection signal that contains information about a measured intensity of the detected fluorescence, i.e. the captured photons. Optionally, the detection signal can contain information about a measured intensity in dependence of an optical wavelength of the detected fluorescence.

The processing unit, e.g. a computer, determines a concentration of the component via the detection signal received from the detection unit. For example, the processing unit is configured to derive the concentration from the detected intensity of the fluorescence within a certain wavelength range, e.g. a range comprising an emission wavelength of the fluorescence of the detergent component. For example, the greater the measured intensity, the higher the concentration. Moreover, the detergent component can have multiple transitions that result in spontaneous emission, i.e. it can have fluorescence at multiple distinct emission wavelengths. In such a case, the processing unit can be configured to determine the concentration based on a comparison of the measured intensities of each of the emission wavelengths.

In an embodiment, the resultant fluorescence comprises monomer emission and excimer emission of the component. For determining the concentration, the processing unit is configured to perform ratiometric fluorescence spectroscopy on the measured intensity.

Some detergent components, such as surfactants, are characterized by their molecules comprising a hydrophilic head region and a hydrophobic single-tail region. At a certain threshold concentration within the fluid, these molecules begin to form micelles, a spherical aggregate of said molecules, in which the hydrophilic head regions are in contact with the surrounding fluid, e. g. a solvent, and sequester the hydrophobic regions in the center of the formed micelle. Such micelles can have fluorescence that is due to an excimer emission, wherein said excimer fluorescence occurs at a wavelength that is different to that of a monomer emission that occurs for individual molecules that have not or not yet formed into a micelle aggregate.

Thus, in these embodiments, in which the target component forms micelles having an excimer fluorescence, the processing unit is configured to analyze the detection signal from the detection unit by comparing the intensity at the excimer emission wavelength to that at the monomer emission wavelength. As the degree of micelle formation versus concentration of the detergent component is a fixed property that can be independently determined, the result of said comparison can give information about a specific prevailing concentration of the detergent component. More specifically, the processing unit can be configured to perform ratiometric fluorescence spectroscopy, in which the ratio between the intensity at the excimer emission wavelength and that at the monomer emission wavelength is calculated. This ratio gives a direct indication of the concentration as more micelles form, the higher the concentration is.

In an embodiment, the processing unit is further configured to determine a deviation of the concentration from a critical micelle concentration, CMC, of the component.

The CMC is a characteristic property of surfactants, e.g. contained in detergents, and describes the concentration of said surfactant above which micelles form. If the concentration is increased further, substantially all of the molecules that are added become micelles. For example, the CMC of linear alkylbenzene sulfonate, LAS, a surfactant commonly used in detergents, is about 0.65 g/l. Only the formation of micelles render the washing cycle with a detergent effective, as these micelles typically trap hydrophobic contaminants within their center.

Having a concentration below the CMC, all, or at least most, of the surfactant molecules remain individual, resulting in the fact that they will float at the surface of the solvent they are dissolved in, i.e. a water-detergent mixture. This is due to the aforementioned hydrophilic part of the molecules. As consequence, a washing cycle at such a low concentration would not be at all efficient as the surfactant molecules at the surface of the solvent are not able to attach to the contaminant particles of the items to be cleaned, e.g. clothes or dishes, and trap these in the center of micelles for efficient cleaning.

A concentration substantially larger than the CMC is tantamount to a waste of detergent. In other words, an optimal amount of detergent for a washing cycle is reached when the surfactant concentration (approximately) equals the CMC of said surfactant.

Thus, the processing unit in these embodiments is configured to compare the determined concentration of the detergent component to its CMC, and to determine a deviation from this comparison. This deviation in turn gives information about whether an amount of detergent in the solvent is optimal, or too high or too low. In consequence, the processing unit can output a signal indicating said deviation to prompt a user of the water-conducting household appliance, which the fluid analysis system can be part of, to act, e.g. to introduce additional detergent.

In an embodiment, the detergent component is a surfactant, in particular linear alkylbenzene sulfonate, LAS.

Alkylbenzene sulfonates are anionic surfactants comprising a hydrophilic sulfonate head-group and a hydrophobic alkylbenzene tail-group. Alkylbenzene sulfonates, particularly LAS, represent the most widely used surfactants employed in laundry detergents and dishwashing liquid. Therein, the term linear in LAS refers to the starting alkene. LAS is found to biodegrade rather quickly, making it an environmental choice of surfactant.

Similar to excimer fluorophores, such as pyrene, LAS likewise exhibits excimer fluorescence when excited with ultraviolet light. Therein, the maximum absorption occurs at a wavelength of about 230 nm. The fluorescence due to monomer emission of LAS is characterized by a wavelength of about 290 nm, while the fluorescence due to excimer emission occurs at about 323 nm.

Hence, at a low LAS concentration, the molecules are sparsely spread at the surface or inside of the solvent, i.e. the water-detergent solution. Upon an excitation of the monomers with UV light at 230 nm, the molecules are excited as monomers and begin to emit fluorescence light at a wavelength of 290 nm. In contrast, at a high LAS concentration, the molecules fully occupy the entire surface of the water and start to aggregate into micelles, causing them to be in close proximity to each other. Therein, excited molecule and ground state molecules start to form excimers, which emit fluorescence light at an even longer wavelength of 323 nm in the case of LAS.

Thus, the target detergent component of the fluid analysis system being LAS enables a label-free determination of the surfactant concentration of most detergents, as LAS to date is the most common surfactant.

In an embodiment, the first wavelength is a wavelength in the ultraviolet domain, in particular of about 230 nm.

In order to efficiently excite widely used surfactants such as LAS, an output wavelength of the light source is set to 230 nm, which is the absorption maximum of LAS, for example. The light source can thus be an ultraviolet, UV, LED or a narrowband light source, such as a UV laser, whose output wavelength comprises 230 nm, i.e. the excitation wavelength of the surfactant, which can be LAS, for instance. Accordingly, the detection unit is configured to detect emitted photons corresponding to the fluorescence wavelength, e.g. 290 nm and 323 nm for LAS, corresponding to its monomer and excimer emission. Alternative light sources with suitable emission in the UV include low-pressure mercury lamps and xenon arc lamps.

In an embodiment, an optical axis of the detection unit is perpendicular to an optical axis of the light source. A transducer of the detection unit, e.g. a spectrometer, can be located at a distance away from the sample at a 90-degree angle with respect to the incident light from the light source. Such an arrangement decreases the susceptibility of the detection unit to stray light from the light source. In this context, the term perpendicular includes arrangements, wherein the detection unit is arranged at approximately but not exactly 90 degrees.

In an embodiment, the light from the light source further comprises white and/or near-infrared, NIR, light. The detection unit is further configured to measure an intensity of the white and/or NIR light emanated, in particular scattered, from the fluid. The detection unit can further be configured to measure an intensity of scattered light of the first wavelength, e.g. UV light.

For example, the light source can comprise a first emitter configured to emit the first wavelength, e.g. UV light, for exciting the target detergent component, and a second emitter emitting white and/or NIR light, e.g. a white LED, a NIR LED, or a hyperspectral VIS-NIR LED. Alternatively, the light source can comprise a single emitter configured to emit broadband light comprising the first wavelength, e.g. a UV wavelength, and visible and/or NIR light. In such embodiments, the detection unit is likewise configured to detect an intensity of said white and/or NIR light that is emanated by the fluid in response to the illumination. To this end, the detection unit can comprise an additional photodiode or by means of a broadband spectrometer.

For example, the detection unit is arranged such that light that is scattered by the fluid is detected. Alternatively, the detection unit is arranged such that light is detected that is transmitted or reflected by the fluid. Therein, scattered light can give information about contaminants within the fluid, e.g. for determining a degree of dirtiness of the fluid. Alternatively, transmitted light can be characterized by absorption lines caused by particles or bacteria in the fluid. Hence, the detected transmitted light can give information about a type of contaminant in the fluid. Furthermore, the white and/or NIR light can be used to determine a turbidity of the fluid, also giving information about a degree of dirtiness.

In an embodiment, the light from the light source further comprises a second wavelength corresponding to an excitation wavelength of a further detergent component, in particular an optical brightener. The detection unit is further configured to measure a further intensity of the resultant fluorescence generated by the further component, and the processing unit is further configured to determine a concentration of the further component based on the measured further intensity by means of fluorescence spectroscopy, in particular by means of ratiometric fluorescence spectroscopy or single intensity fluorescence spectroscopy for optical brighteners that do not exhibit a change in intensity of two different wavelengths.

In addition to performing (ratiometric) fluorescence spectroscopy on the detergent component, e.g. a surfactant, as described, a similar procedure can be performed for a further detergent component, e.g. a brightener. Optical brighteners are synthetic chemicals added in laundry detergents, for example, to make clothing appear whiter and brighter after the washing cycle. Optical brighteners do not contribute to the actual cleaning process, are not readily biodegradable and can thus bio-accumulate in the environment, which poses a potential hazard to aquatic life. Therefore, management of an optical brightener concentration is vital when dosing a detergent. Optical brighteners typically absorb UV light and emit visible blue light with a peak of around 420 nm.

Like LAS, optical brighteners experience a monomer and excimer emission of different wavelengths. Thus, a ratiometric spectroscopy can be performed, in which the processing unit is configured to determine a ratio between the intensity at the excimer emission wavelength and that at the monomer emission wavelength. This ratio again gives a direct indication of the concentration of the further component in a similar manner. For excitation purposes, the light source in these embodiments is further configured to illuminate the fluid with light of said second wavelength, which is the excitation wavelength of the further component, e.g. 420 nm for optical brighteners. Hence, in combination with the ratiometric fluorescence performed with the surfactant, a further fluorescence signal can be measured and quantized using the same platform providing multiplexing.

In an embodiment, the fluid analysis system further comprises a further detection unit that is positioned and configured to measure a first transmission intensity of the light emitted by the light source and transmitted by the fluid, wherein the processing unit is further configured to determine a concentration of contaminants in the fluid based on the measured first transmission intensity.

For example, the detection unit is arranged distant from the fluid in a perpendicular manner with respect to an optical path formed by an emission direction of the light source as already discussed above. The further detection unit is arranged distant from the fluid on the optical path of the light source. In other words, the further detection unit is arranged on the axis of light emission of the light source, with the fluid to be analyzed located in between. This way, the detection unit is configured to detect the fluorescence of the component and optionally also scattered light without being susceptible to the illumination light from the light source. The further detection unit, on the other hand, is configured to directly detect any light that is emanated by the fluid, i.e. light that is transmitted and emitted.

From the intensity signal of the further detection unit, the processing unit can determine a concentration and type of contaminants in the fluid, such as bacteria. For example, the first transmission intensity is detected in the UV, visible and/or NIR domain.

In a further embodiment, the further detection unit is configured to measure the first transmission intensity in the in the UV domain or in a visible and NIR domain.

Transmitted light in the visible and NIR domain can comprise absorption lines in the detected light at the further detection unit, which in turn can give information about type, size and concentration of particles in the fluid. This way, for example contaminants can be detected delivering a measure for a degree of dirtiness of the fluid. In the UV domain, on the other hand, absorption lines can give information about a concentration and type of bacteria contained in the fluid.

In an embodiment, the fluid analysis system further comprises a further light source having an optical axis that is perpendicular to an optical axis of the light source, wherein the further light source is configured to illuminate the fluid with light. The detection unit is further configured to measure a second transmission intensity of the light emitted by the further light source and transmitted by the fluid, and the processing unit is further configured to determine a concentration of contaminants in the fluid based on the measured second transmission intensity.

In addition or alternatively to the further detection unit, the system can comprise a further light source that emits light in a perpendicular manner with respect to the light source. This way, likewise ratiometric fluorescence spectroscopy as well as transmission measurements can be performed. For example, in a first step, a driver unit, which can be part of the fluid analysis system, is configured to synchronize an operation of the light source and the detection unit for performing (ratiometric) fluorescence spectroscopy, while in a second step said driver unit is configured to synchronize an operation of the further light source and the detection unit for performing the transmission/absorption measurement. Synchronizing in this context means, that an emission of the respective light source is enabled while that of the other light source is disabled, while at the same time the detection unit is set to detect incoming photons.

In an embodiment, the processing unit is further configured to determine a turbidity of the fluid based on the measured intensity.

The turbidity of the fluid can be determined by means of a transmission measurement, or by performing a ratiometric measurement via comparing an intensity of white and/or NIR light detected by a detector arranged at 90° with respect to the light source, and an intensity of white and/or NIR light detected by a detector arranged at 180° with respect to the light source. The turbidity can be used to further determine whether additional cleaning is necessary or whether additional detergent is required during an ongoing washing cycle.

In an embodiment, the fluid analysis system further comprises a driver unit that is configured to synchronize an emission of the light source and an integration time of the detection unit. For energy efficiency, the fluid can only be analyzed at certain times during a washing cycle, e.g. at the end of different washing steps to determine whether sufficient detergent is present and/or whether the items are sufficiently clean. To this end, the driver unit can activate an emission of the light source and at the same time enable a detection of the detection unit.

In a further embodiment, the driver unit is configured to operate the light source in a pulsed manner. As the lifetime of photoluminescence is typically in the order of nanoseconds, the driver unit can pulse the light source and subsequently activate a detection of the detection unit. This way, noise due to the illuminating light can be further substantially suppressed.

In an embodiment, the fluid analysis system is a semiconductor integrated circuit device arranged on a chip substrate. For rendering the system suitable for various types of appliances and to make it cost and energy efficient, the system can be realized as a system-on-a-chip, meaning that all described components are arranged on a common chip substrate and manufactured following a CMOS compatible manufacturing process, for instance. To this end, a fluid channel can be arranged in between the optical elements for guiding a fluid through the probing volume defined by the illumination of the light source and a field-of-view of the detection unit.

Furthermore, a water-conducting household appliance is provided that comprises a fluid analysis system according to one of the embodiments described above. This means that all features disclosed for the fluid analysis system are also disclosed for and applicable to the water-conducting household appliance and vice-versa. For example, the water-conducting household appliance is a washing machine or a dishwasher. The term home appliance is used to describe the nature of the appliances and does not limit an application purely to end consumers. In contrast, also industrial and commercial water-conducting appliances can benefit from the improved concept.

In some embodiments, the water-conducting household appliance further comprises a detergent dispenser having a controller, wherein the controller is configured to control a dispensing of detergent based on the determined concentration received from the fluid analysis system. The concentration of a surfactant and optionally also of a brightener determined by the fluid analysis system can be used to ensure an optimal amount of detergent within the appliance during a washing cycle, e.g. within a drum of a washing machine. To this end, the determined concentration can be used as a control signal of a detergent dispenser.

Furthermore, a method for determining a concentration of a detergent component in a fluid is provided. The method comprises illuminating the fluid with light comprising a first wavelength corresponding to an excitation wavelength of the detergent component, measuring an intensity of the resultant fluorescence generated by the component, and determining from the measured intensity the concentration via fluorescence spectroscopy.

Further embodiments of the method become apparent to the skilled reader from the embodiments of the fluid analysis system described above, and vice-versa.

### BRIEF DESCRIPTION OF THE DRAWINGS

The following description of figures may further illustrate and explain aspects of the fluid analysis system and the method for determining a concentration of a detergent component in a fluid. Components and parts of the fluid analysis system that are functionally identical or have an identical effect are denoted by identical reference symbols. Identical or effectively identical components and parts might be described only with respect to the figures where they occur first. Their description is not necessarily repeated in successive figures.

### DETAILED DESCRIPTION

In the figures:

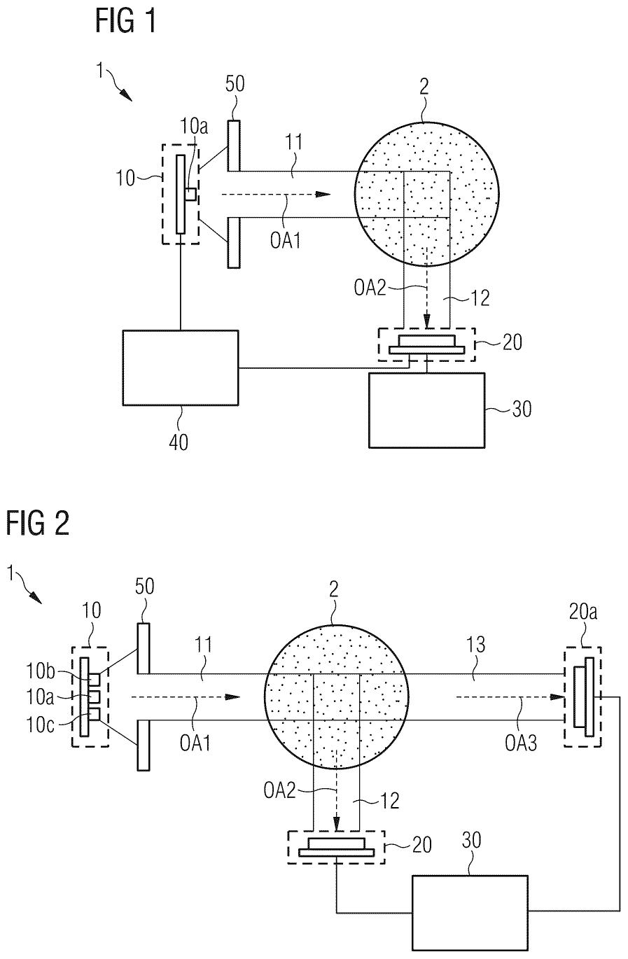

FIGS. 1 to 4 show exemplary embodiments of a fluid analysis system according to the improved concept;

FIG. 5 shows an exemplary embodiment of a water-conducting household appliance comprising a fluid analysis system;

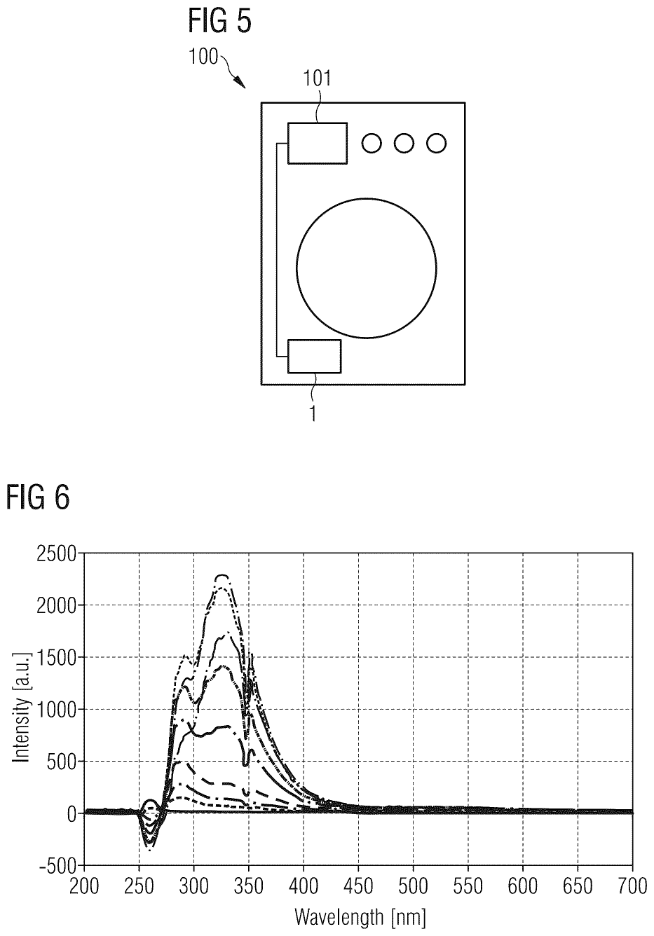

FIG. 6 shows an exemplary fluorescence spectrum of a detergent component;

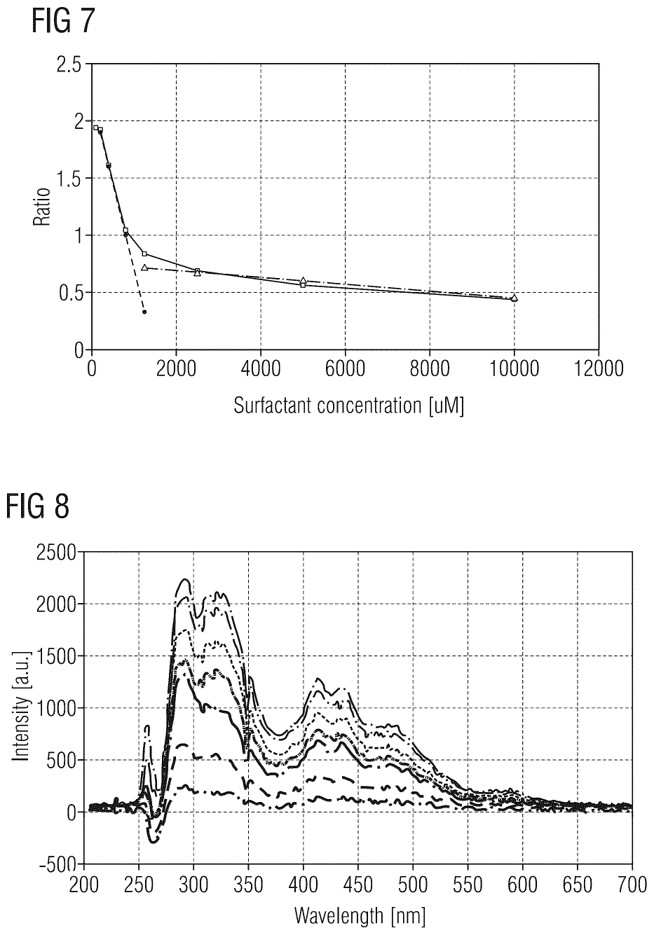

FIG. 7 shows an exemplary ratio of monomer and excimer emission of the detergent component; and

FIG. 8 shows an exemplary fluorescence spectrum of a further detergent component.

FIG. 1 shows a first exemplary embodiment of a fluid analysis system 1 according to the improved concept. The fluid analysis system 1 comprises a light source 10 configured to emit light 11 that comprises the first wavelength, i.e. the excitation wavelength of the detergent component dissolved within a fluid 2. For example, the light source 10 comprises a first emitter 10a that is a narrowband emitter, e.g. a laser such as a VCSEL or laser diode, or a broadband emitter, such as an LED, for emitting light 11 comprising the first wavelength towards the fluid 2 for illuminating the latter. For restricting an illumination angle and to ensure that substantially only the fluid 2 is illuminated, the fluid analysis system 1 can further comprise an aperture 50 arranged on the optical axis OA1 in between the light source 10 and the sampling region, i.e. the location of the fluid 2.

For example, the targeted detergent component is a surfactant such as linear alkylbenzene sulfonate, LAS, which is characterized by a maximum absorption wavelength of 230 nm, which is in the ultraviolet domain. Thus, the emitter 10a can be a UV LED that emits light 11 having a spectrum that comprises said wavelength of 230 nm. Moreover, LAS is characterized by emanating fluorescence due to a monomer emission at 290 nm and due to an excimer emission at 323 nm. Therein, the monomer emission is caused by LAS molecules that have not been arranged in micelle aggregates, while the excimer emission takes place for molecules arranged in micelles. The formation of micelles is concentration-dependent and is initiated at a certain concentration of the surfactant within the solvent, e.g. a water-detergent mixture.

The fluid analysis system 1 further comprises a detection unit 20 positioned and configured to measure an intensity of the resultant light 12 emanated by the detergent component, i.e. the aforementioned fluorescence due to monomer and excimer relaxation occurring within the surfactant molecules. For example, the detection unit 20 comprises means to convert photons into an electronic signal in the form of electronic charge, current or voltage. Said means can be realized by means of one more photodetectors, e.g. having photodiodes that are sensitive at the emission wavelength of the fluorescence at 290 nm and 323 nm, or a spectral sensor, such as an optical spectrometer, being able to separate and measure spectral components of the photons received.

The detection unit 20 generates an electronic detection signal that contains information about a measured intensity of the detected fluorescence, i.e. the captured photons. Optionally, the detection signal can contain information about a measured intensity in dependence of an optical wavelength of the detected fluorescence. For example, the detection signal comprises information about a first intensity from a monomer emission and about a second intensity from an excimer emission of the surfactant.

The detection unit 20 is arranged such that its optical axis OA2 is perpendicular, or substantially perpendicular, to the optical axis OA1 of the light source 10. Such a fluorimeter arrangement decreases the susceptibility of the detection unit 20 to stray light from the light source 10 or light that is transmitted through the fluid 2.

The fluid analysis system 1 further comprises a processing unit 30, to which the detection unit 20 is coupled. The detection unit 20 provides the electronic detection signal to the processing unit 30. The processing unit 30 comprises means, e.g. a computer, for calculating from the electronic detection signal the concentration of the surfactant in the fluid 2. For example, the detection unit 20 performs ratiometric fluorescence spectroscopy, wherein a ratio between the measured intensity at 323 nm, i.e. the excimer emission, and the measured intensity at 290 nm, i.e. the monomer emission, is calculated. This value can be directly converted to a concentration of the detergent component by means of a lookup table, as this ratio is directly dependent on the concentration and is a known quantity of any given surfactant within a detergent.

The processing unit 30 can be further configured to determine a deviation between the determined concentration and a critical micelle concentration, CMC. The latter quantity specifies the concentration, at which the surfactant form into micelles, which is a crucial condition for an efficient cleaning cycle. The processing unit 30 can output the determined concentration and/or the aforementioned deviation from the CMC to a user, e.g. via a notification, or to a different component of a water-conducting household appliance, e.g. a detergent dispenser, for controlling an amount of detergent.

The fluid analysis system 1 in this first embodiment further comprises a driver unit 40 configured to synchronize an emission of the light source 10 and an integration time of the detection unit 20. For energy-efficient operation, the light source 10 and the detection unit 20, and optionally the processing unit 30, only need to be activated when a concentration is to be determined, e.g. at a certain point of a washing cycle. To this end, the driver unit 40 that is coupled to the aforementioned elements of the fluid analysis system 1 activates and deactivates emission from the emitter 10a of the light source 10, activates an integration time of the detection unit 20 and a processing of the detection signal by means of the processing unit 30. Controlling the emission of the light source 10 can further serve the purpose of avoiding the detection of stray light from the light source 10. For example, the driver unit 40 operates the emitter 10a of the light source 10 in a pulsed manner and, due to the finite but non-zero lifetime of the excited state of the detergent component, initiates the integration time shortly after a pulse.

All components of the fluid analysis system 1 can form an integrated device, e.g. a CMOS device, on a common chip substrate, for instance. A microchannel or cuvette can serve as means to arrange the fluid 2 to be analyzed in the sampling region, i.e. in the center of the fluorimeter arrangement.

FIG. 2 shows a second exemplary embodiment of a fluid analysis system 1. Compared to the first embodiment, the light source 10 in this embodiment comprises further emitters 10b, 10c for emitting light at wavelengths different than the emitter 10a. For example, the emitter 10b is a white LED that emits light in the visible range, and the emitter 10c is a NIR LED that emits light in the near-infrared domain (or vice versa). Like the emitter 10a, the further emitters 10b, 10c emit light 11 along the optical axis OA1 for illuminating the fluid 2. However, also embodiments with just one further emitter realize the improved concept, wherein the one further emitter can be a visible or a NIR emitter, or an emitter that emits both visible and NIR radiation, for instance. Likewise, the light source 10 can comprise a single broadband emitter that emits light in the UV, visible and NIR range.

The fluid analysis system 1 in this second embodiment further comprises a further detection unit 20a that is arranged in a manner such that its optical axis OA3 is collinear to the optical axis OA1 of the light source 10. In other words, the further detection unit 20a is arranged at a 180° angle with respect to the light source 10. The further detection unit 20a can be configured to detect light in the visible and/or NIR domain that is emanated from the fluid 2 by means of transmission. In other words, the further detection unit 20a can be configured to detect absorption/transmission spectra of particles in the fluid, e.g. for determining a degree of contamination, i.e. a degree of dirtiness. Likewise, the further detection unit 20a can be configured to detect light in the UV domain that is emanated from the fluid 2 by means of transmission. In other words, the further detection unit 20a can be configured to detect absorption/transmission spectra of bacteria, typically being fluorescent in the UV, in the fluid.

Likewise, the detection unit 20 arranged at 90° with respect to the light source 10 can be further configured to detect a fluorescence of a further detergent component, e.g. a brightener. Brighteners are typically characterized by both an excitation wavelength and a fluorescence wavelength that are different than that of a surfactant, e.g. LAS. For example, a brightener in the fluid 2 comprises monomer and excimer emissions at 420 nm and 435 nm. To this end, the emitted light 11 of the light source 10, e.g. of the emitter 10a, comprises a second wavelength that corresponds to the excitation wavelength of the brightener, which is likewise in the UV domain. Furthermore, the detection unit 20 can also be configured to detect light in the visible and/or NIR domain, e.g. light that is scattered from particles in the fluid 2.

The processing unit 30 in this embodiment, in addition to the aforementioned ratiometric fluorescence spectroscopy, can be further configured to perform a fluorescence measurement on the fluorescence from the further component for determining a concentration of the further detergent component within the fluid 2, e.g. also via ratiometric fluorescence spectroscopy in an analogous manner. The processing unit 30 can be further configured to determine from the signals of the detection unit 20, particularly the signals due to detected light in the visible and/or NIR wavelength range, and of the further detection unit 20a a degree of contamination of the fluid 2. Furthermore, the processing unit 30 can be configured to determine a turbidity of the fluid 2 from the signals of the detection units 20, 20a, e.g. via a ratiometric process, in the NIR and/or visible domain. Likewise, the processing unit 30 can be configured to perform a compensation algorithm from the fluorescence and absorption measurements particularly in the UV regime using the signals of both detection units 20, 20a. The compensation algorithm ensures that the first wavelength, e.g. UV light, is relative to only the absorption of the target contaminant or bacteria. Thus, the absorption of UV light to produce fluorescence must be distinguished from this.

The driver unit 40 is omitted for illustrative purposes only, however, can also be comprised by the fluid analysis system 1 according to the second exemplary embodiment.

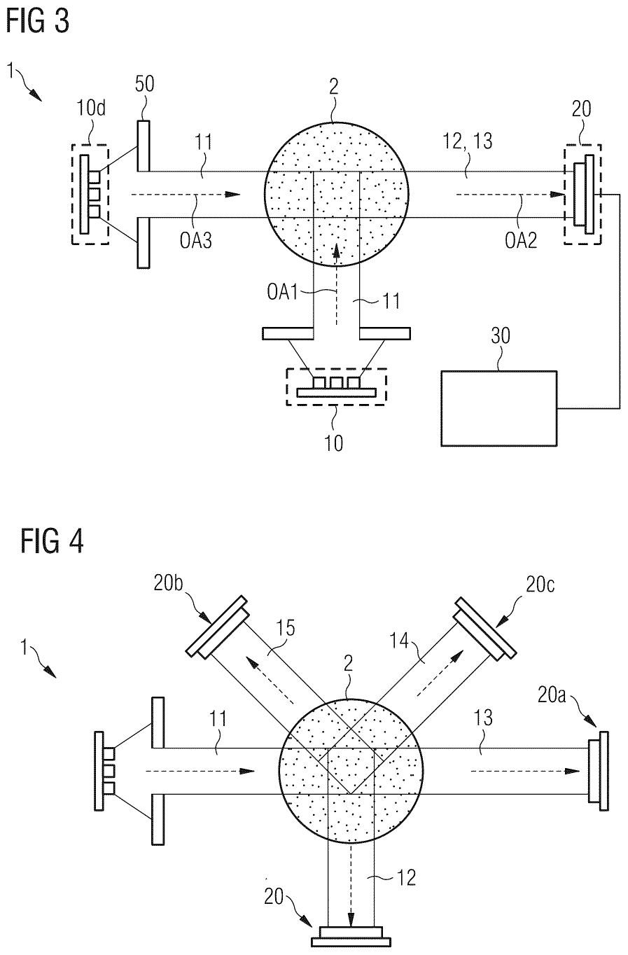

FIG. 3 shows a third exemplary embodiment of a fluid analysis system 1. Compared to the first embodiment, the fluid analysis system 1 in this embodiment comprises a further light source 10d that is arranged 180° with respect to the detection unit 20 and 90° with respect to the light source 10. In other words, an optical axis OA3 of the further light source 10d is collinear with the optical axis OA2 of the detection unit. In this embodiment, both the light source 10 and the further light source 10d comprise multiple emitters 10a, 10b, 10c for emitting a broadband spectrum of light 11 for illuminating the fluid 2.

Analogous to the second embodiment of FIG. 2, this arrangement likewise enables ratiometric fluorescence spectroscopy and 90° scattering measurements using the light 11 from the light source 10 at the 90° arrangement, and transmission/absorption measurements using the further light source 10d at the 180° arrangement. Likewise the aforementioned turbidity determination and compensation algorithm are possible in this arrangement. The driver unit 40, not shown, can be configured to control an emission of the light sources 10, 10d such that in a measurement phase, only one of the light sources 10, 10d is emitting light at a time. This way, unwanted stray light from the respective other light source is prevented.

It shall be noted that a combination of the embodiments of FIGS. 2 and 3 likewise solves the object to be achieved. An embodiment featuring two light sources 10, 10 d arranged 90° with respect to each other, and two detection units 20, 20a also arranged 90° with respect to each other can further aid to more accurately determine the concentration of the detergent component as well as of the further component and/or for more precise estimations of contamination levels and turbidity of the fluid 2.

FIG. 4 shows a fourth exemplary embodiment of a fluid analysis system 1. Compared to the second embodiment of FIG. 2, the system 1 here further comprises additional detection units 20b, 20c arranged at various angles for detecting light 14, 15 that is forward and backward scattered from particles within the fluid 2, respectively. Signals from these additional detection units 20b, 20c can be provided to the processing unit 30 for determining a degree of contamination and/or for identifying size and type of particles dissolved in the fluid 2.

FIG. 5 shows an exemplary embodiment of a water-conducting household appliance 100 comprising a fluid analysis system 1. For example, the household appliance 100 is a washing machine for clothes or a dishwasher. Household appliance in this context also includes industrially and commercially used appliances of the same type. The household appliance 100 comprises a fluid analysis system 1 according to the improved concept, e.g. according to one of the embodiments described above, wherein the fluid analysis system 1 is configured to determine a concentration of a surfactant within a fluid 2. For example, the fluid analysis system 1 is arranged such that a water-detergent mixture is probed during recycling of said mixture in between steps of a cleaning cycle, for instance. Thus, the fluid analysis system 1 is arranged to probe the fluid 2 within a (transparent) tube or reservoir within the household appliance 100. In conventional approaches, the turbidity sensor is typically placed under the drum of a side-loading washing machine or placed at the drainage of water for top-loading washing machines. A fluid analysis system 1 according to the improved concept can likewise be placed in a corresponding location. Thus, a fluid analysis system 1 according to the improved concept can be configured to determine the detergent concentration and that of a contaminant after each washing cycle in order to eventually determine the amount of detergent to be added.

The household appliance 100 can further comprise a detergent dispenser 101, which is configured to automatically dispense and add detergent to the solvent within the appliance. For example, the detergent dispenser 101 receives a prompt from the fluid analysis system 1 to begin or terminate dispensing detergent, wherein said prompt depends on a determined concentration of the detergent component, the further detergent component and/or a deviation from a critical micelle concentration, CMC. Alternatively, the household appliance 100 can comprise means, e.g. a display or acoustic port, for notifying a user of how much detergent to add in order to reach the optimal operation point, i.e. a point close to the CMC of the detergent's surfactant.

The fluid analysis system 1 can further comprise a pH sensor for determining the hardness of the water. Furthermore, the household appliance 100 can comprise means to determine a resistance of a motor of a drum of a washing machine, for instance, for determining a weight and volume of a load.

Thus, the concentration of the surfactant, the concentration of the brightener, the pH value, the weight and volume of the load and the turbidity of the fluid can be combined when determining an optimal amount of detergent for a specific wash cycle.

FIG. 6 shows an exemplary fluorescence spectrum of a detergent component, which in this case is LAS. The graph shows a detected fluorescence intensity versus optical wavelength for different concentrations of the surfactant. The different curves indicate different concentrations of the surfactant within the fluid. Therein, a curve with a higher signal at a specific wavelength has a higher concentration of the surfactant. As can be seen, the curves show double peaks at 290 nm at 323 nm characteristic for the fluorescence due to monomer and excimer emissions, respectively.

FIG. 7 shows the ratio of the peaks of FIG. 6 for each of the concentrations. In other words, FIG. 7 shows a graph indicating the intensity at 290 nm divided by the intensity at 323 nm plotted against the set concentrations of the previous graph. The dashed lines indicate linear fits to the steep and shallow portions of the graph. As can be seen, the two fits intersect at a concentration of about 1000 micro molar, μM, which corresponds to the CMC of LAS and constitutes the preferred concentration, at which micelles form. A larger surfactant concentration is tantamount to a waste of detergent while a lower concentration leads to the surfactant not arranging in micelles, therefore not allowing for an efficient cleaning process.

FIG. 8 shows an exemplary fluorescence spectrum of a further detergent component, which in this case is a brightener.

Optical brighteners are synthetic chemicals added in laundry detergents to make clothing appear white and brighter. Thus, brighteners typically absorb UV light and emit blue light with peaks around 420 nm, hence overshadowing the amount of reflected yellow light for making the clothing seem whiter and brighter. Optical brighteners do not contribute to any the cleaning process of the detergent and not readily biodegradable. Instead molecule of brighteners may bio-accumulate in the environment, which poses a potential hazard to aquatic life. Therefore, management of an amount of optical brighteners is vital. Hence, as mentioned before, together with the ratiometric fluorescence spectroscopy of the surfactant, an analogous measurement of another fluorescence signal from a brightener can be performed using the same platform, hence providing multiplexing.

This patent application claims the priority of German patent application DE 102022104818.7, the disclosure content of which is hereby incorporated by reference.

The embodiments of the fluid analysis system 1 and the method of determining a concentration of a detergent component disclosed herein have been discussed for the purpose of familiarizing the reader with novel aspects of the idea. Although preferred embodiments have been shown and described, changes, modifications, equivalents and substitutions of the disclosed concepts may be made by one having skill in the art without unnecessarily departing from the scope of the claims.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

### References

1 fluid analysis system
2 fluid
10, 10d light source
10a, 10b, 10c emitter
11 emitted light
12 fluorescence
13 transmitted light
14, 15 scattered light
20, 20a, 20b, 20c detection unit
30 processing unit
40 driver unit
50 aperture
OA1, OA2, OA3 optical axis

1. A fluid analysis system for determining a concentration of a detergent component in a fluid, comprising:
a light source configured to illuminate the fluid with light, the light comprising a first wavelength corresponding to an excitation wavelength of the detergent component;
a detection unit positioned and configured to measure an intensity of the resultant fluorescence generated by the detergent component; and
a processing unit configured to determine the concentration based on the measured intensity by means of fluorescence spectroscopy, wherein
the resultant fluorescence comprises monomer emission and excimer emission of the component; and
for determining the concentration, the processing unit is configured to perform ratiometric fluorescence spectroscopy on the measured intensity.

2. The fluid analysis system according to claim 1, wherein the processing unit is further configured to determine a deviation of the concentration from a critical micelle concentration of the component.

3. The fluid analysis system according to claim 1, wherein the detergent component is a surfactant, in particular linear alkylbenzene sulfonate.

4. The fluid analysis system according to claim 1, wherein the first wavelength is a wavelength in the ultraviolet domain, in particular of about 230 nm.

5. The fluid analysis system according to claim 1. wherein an optical axis of the detection unit is perpendicular to an optical axis of the light source.

6. The fluid analysis system according to claim 1, wherein
the light from the light source further comprises white and/or near-infrared, NIR, light; and
the detection unit is further configured to measure an intensity of white and/or NIR light emanated, in particular scattered, from the fluid.

7. The fluid analysis system according to claim 1, wherein
the light from the light source further comprises a second wavelength corresponding to an excitation wavelength of a further detergent component, in particular an optical brightener; and
the detection unit is further configured to measure a further intensity of the resultant fluorescence generated by the further detergent component; and
the processing unit is further configured to determine a concentration of the further detergent component based on the measured further intensity by means of fluorescence spectroscopy, in particular by means of ratiometric fluorescence spectroscopy.

8. The fluid analysis system according to claim 1, further comprising a further detection unit that is positioned and configured to measure a first transmission intensity of the light emitted by the light source and transmitted by the fluid, wherein the processing unit is further configured to determine a concentration of contaminants in the fluid based on the measured first transmission intensity.

9. The fluid analysis system according to claim 8, wherein the further detection unit is configured to measure the first transmission intensity in the UV domain or in a visible and NIR domain.

10. The fluid analysis system according to claim 1, further comprising a further light source having an optical axis that is perpendicular to an optical axis of the light source, wherein
the further light source is configured to illuminate the fluid with light;
the detection unit is further configured to measure a second transmission intensity of the light emitted by the further light source and transmitted by the fluid; and
the processing unit is further configured to determine a concentration of contaminants in the fluid based on the measured second transmission intensity.

11. The fluid analysis system according to claim 1, wherein the processing unit is further configured to determine a turbidity of the fluid based on the measured intensity.

12. The fluid analysis system according to claim 1, further comprising a driver unit that is configured to synchronize an emission of the light source and an integration time of the detection unit.

13. The fluid analysis system according to claim 12, wherein the driver unit is configured to operate the light source in a pulsed manner.

14. The fluid analysis system according to claim 1, wherein the fluid analysis system is a semiconductor integrated circuit device arranged on a chip substrate.

15. A water-conducting household appliance comprising a fluid analysis system according to claim 1.

16. The water-conducting household appliance according to claim 15, further comprising a detergent dispenser having a controller, wherein the controller is configured to control a dispensing of detergent based on the determined concentration received from the fluid analysis system.

17. A method for determining a concentration of a detergent component in a fluid, comprising:
illuminating the fluid with light comprising a first wavelength that corresponds to an excitation wavelength of the detergent component;
measuring an intensity of the resultant fluorescence generated by the component; and
determining from the measured intensity the concentration via fluorescence spectroscopy, wherein
the resultant fluorescence comprises monomer emission and excimer emission of the component; and
for determining the concentration, ratiometric fluorescence spectroscopy is performed on the measured intensity.
